(19) United States
(12) Patent Application Publication
(10) Pub. No.: US 2004/0161000 A1
(43) Pub. Date: Aug. 19, 2004

(54) Uncooled optical communication module

(76) Inventors: Byung-Kwon Kang, Suwon-shi (KR); Seung-Won Lee, Suwon-shi (KR); June-Hyeon Ahn, Suwon-shi (KR); Shi-Yun Cho, Seoul (KR)

Correspondence Address: CHA & REITER, LLC, 210 ROUTE 4 EAST STE 103, PARAMUS, NJ, 07652, US

(21) Appl. No.: 10/665,269

(22) Filed: Sep. 18, 2003

(30) Foreign Application Priority Data
Feb. 13, 2003 (KR) 2003-9145

(51) Int. Cl. H01S 3/04

(52) U.S. Cl. 372/34

(57) ABSTRACT

An optical communication module is disclosed. The optical communication module includes a thermistor, which may be plate shaped, having a positive temperature coefficient. The resistance of the thermistor increases according to an increase of the environmental temperature. The optical communication module also includes a semiconductor chip mounted on the upper surface of the thermistor, and a driving means for applying a predetermined voltage to the thermistor.

### CLAIM OF PRIORITY

This application claims priority to an application entitled “Uncooled optical communication module,” filed in the Korean Intellectual Property Office on Feb. 13, 2003 and assigned Serial No. 2003-9145, the contents of which are hereby incorporated by reference.

### BACKGROUND OF THE INVENTION

1. Field of the Invention

The present invention relates to an optical communication system, more particularly to an optical communication module included in an optical communication system.

2. Description of the Related Art

The use of optical communication is becoming more widespread and is being applied to various fields. The demand for economical optical communication modules capable of high-speed operation is also increasing.

As background, for a semiconductor laser chip, the optical output and the signal modification characteristic are sensitive to changes of operation temperature. Such a temperature-sensitive optical element requires a means for keeping a predetermined operation temperature.

FIG. 1 shows the construction of a conventional optical communication module. The conventional optical communication module includes a thermoelectric cooler 110, a voltage source 120, a substrate 130, a submount 140, a semiconductor laser chip 150, a submodule 160, a ferrule 170, a temperature sensor 190, and a controller 200.

The thermoelectric cooler 110 operates by means of applied direct voltage, heats or cools the semiconductor laser chip 150 by controlling a predetermined temperature according to an input control signal. The voltage source 120 provides the thermoelectric cooler 110 with a predetermined direct voltage. The substrate 130 is attached on the thermoelectric cooler 110 and the submount 140 is attached on the substrate 130. The semiconductor laser chip 150, attached on the submount 140, emits light of predetermined wavelength, and has a characteristic in which an oscillation wavelength changes according to changes in the operation temperature. The submodule 160 has an internal space that enables the ferrule 170 to be inserted, and the submodule 160 is attached on the substrate 130. The ferrule 170 has a shape of cavity cylinder that enables an optic fiber 180 to be inserted. The ferrule 170 is inserted to the internal space of the submodule 160, and is joined in the submodule 160 in a state wherein an end cross section of the optic fiber 180 is aligned to one end of the semiconductor laser chip 150. The temperature sensor 190 senses the operation temperature of the semiconductor laser chip 150 and outputs a temperature data signal to the controller 200. The controller 200 outputs a control signal according to the input temperature data signal. In this way, the operation temperature of the semiconductor laser chip 150 is kept at a predetermined value.

However, the conventional optical communication module as described above needs a thermoelectric cooler capable of performing heating and forced cooling, and temperature sensing and control elements such as a temperature sensor, in order to keep the operation temperature of the semiconductor chip at a predetermined value.

Accordingly, the conventional optical communication module is problematic in that the volume and manufacturing cost of the total optical communication module are increased.

To solve the problems described above, various studies have focused on improving the temperature characteristic of the semiconductor chip itself. These studies have attempted to find a semiconductor material that has a small characteristic change when operated at temperature range of −15 to 85° C. However, as the characteristics of the semiconductor material naturally change according to a temperature, it is difficult for the optical communication module to ensure a similar transmission characteristic at a wide temperature range by means of this approach.

### SUMMARY OF THE INVENTION

Accordingly, one aspect of the present invention is to solve the above-mentioned problems occurring in the prior art.

Another aspect of the present invention is to provide an optical communication module, which not only can effectively deal with changes in the environmental temperature but also can reduce the volume and manufacturing cost of the total optical communication module.

One embodiment of the present invention is directed to an optical communication module including a thermistor having a shape of plate, a thermistor having a positive temperature coefficient which implies that a resistance increases according to an increase of an environmental temperature, a semiconductor chip mounted on the upper surface of the thermistor, and, a driving means for applying a predetermined voltage to the thermistor.

### BRIEF DESCRIPTION OF THE DRAWINGS

The above features and advantages of the present invention will be more apparent from the following detailed description taken in conjunction with the accompanying drawings, in which:

FIG. 1 is a diagram showing a construction of a conventional optical communication module;

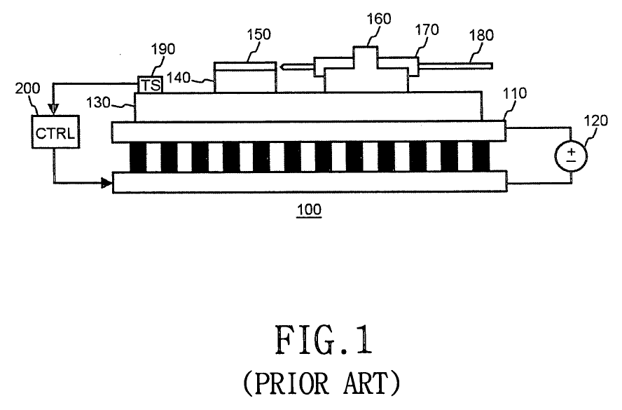

FIG. 2 is a diagram showing a construction of an uncooled optical communication module in accordance with a preferred embodiment of the present invention;

FIG. 3 is a perspective diagram enlarging a part of the optical communication module shown in FIG. 2;

FIG. 4 is a graph showing a resistance characteristic according to the environmental temperature of a thermistor shown in FIG. 2; and,

FIG. 5 is a graph showing a heating characteristic according to the environmental temperature of a thermistor shown in FIG. 2.

### DETAILED DESCRIPTION OF THE PREFERRED EMBODIMENT

Hereinafter, a preferred embodiment according to the present invention will be described with reference to the accompanying drawings. For the purposes of clarity and simplicity, a detailed description of known functions and configurations incorporated herein will be omitted as it may obscure the subject matter of the present invention.

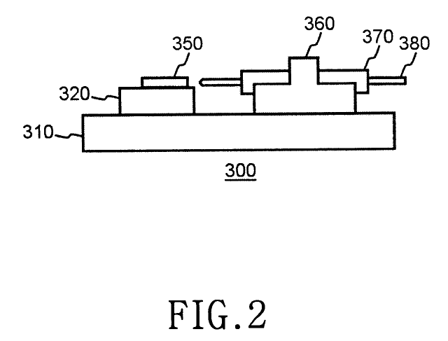

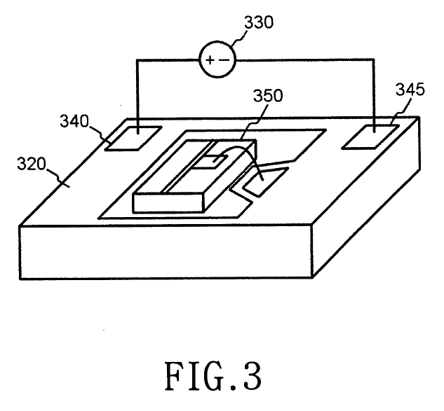

FIG. 2 is a diagram showing the construction of an uncooled optical communication module 300 in accordance with a preferred embodiment of the present invention, and FIG. 3 is a perspective diagram enlarging a part of the optical communication module 300 shown in FIG. 2. The optical communication module 300 includes a substrate 310, a thermistor 320, a semiconductor laser chip 350, a submodule 360, a driving means 330, 340, 345 and a ferrule 370.

The substrate 310 provides a space that enables other elements to be mounted on the upper surface of the substrate 310. The substrate 310 may be made from a kovar material so that laser welding may easily be implemented with other elements.

The thermistor 320 may be attached to the upper surface of the substrate 310. The thermistor 320 has a positive temperature coefficient which implies that the resistance of the thermistor 320 increases according to an increase of an environmental temperature. Preferably, the thermistor 320 has a shape of plate so that the semiconductor laser chip 350 can be mounted on the upper surface of the thermistor 320. But it should be understood that the thermistor 320 may have other shapes (e.g., square, rectangle, irregular) as long as the semiconductor laser chip 350 can be thermally coupled to the thermistor 320. The thermistor 320 may be made from a polycrystal ceramic material, which has a semiconductor characteristic due to added dopants although it normally has a large resistance.

The thermistor 320 may be manufactured by adding yttrium, manganese, tantalum and silica to a combination of barium titanate, lead titanate, and strontium titanate. In order to ensure proper characteristics, it is necessary to select suitable material, suitable particle size, etc. The thermistor 320 has a heating characteristic defined by the following equation 1.

$$P = \frac{{V}^{2}}{R} \qquad Equation 1$$

In equation 1, P represents the power consumption amount corresponding to the heating value of the thermistor 320, V represents the voltage applied to the thermistor 320, and R represents the resistance of the thermistor 320.

When a predetermined constant direct voltage is applied to the thermistor 320, the heating value of the thermistor 320 changes according to a change of an environmental temperature. When the environmental temperature is reduced, the heating value is increased by reduction of resistance, and when the environmental temperature increases, the heating value is reduced by increase of resistance. The thermistor 320 constantly keeps an operation temperature of the semiconductor laser chip 350 at a predetermined temperature range.

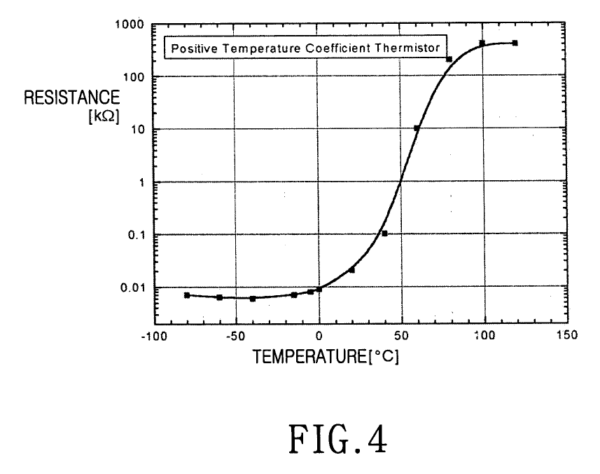

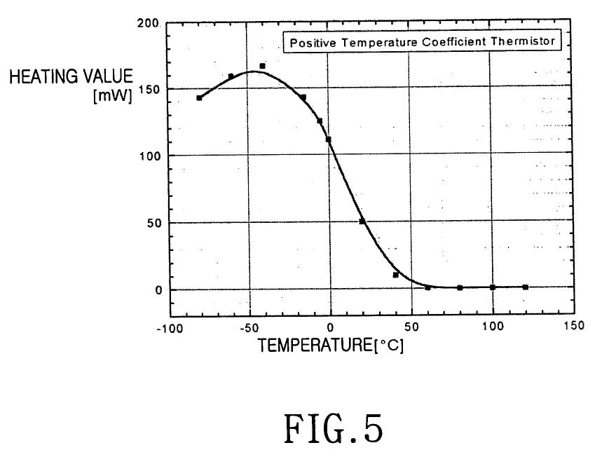

FIG. 4 is a graph showing a resistance characteristic of the thermistor 320 according to environmental temperature, FIG. 5 is a graph showing a heating characteristic of the thermistor 320 according to environmental temperature. At a temperature of more than −40° C., the resistance of the thermistor 320 is increased by an increase in the environmental temperature, and thus the heating value of the thermistor 320 reduces. In contrast, the resistance of the thermistor 320 is reduced by a reduction of an environmental temperature, and thus the heating value of the thermistor 320 increases.

Referring again to FIG. 2 and FIG. 3, the semiconductor laser chip 350, attached on the thermistor 320, emits light through one end of the semiconductor laser chip 350, and has a characteristic in which an oscillation wavelength changes according to the change of an operation temperature.

The driving means applies a predetermined direct voltage to the thermistor 320. The driving means includes a first and second electrode 340, 345, and a voltage source 330. The first and second electrodes 340, 345 are laminated on both sides of the upper surface of the thermistor 320, and the semiconductor laser chip 350 is placed between the first and second electrodes 340, 345. The voltage source 330 applies the predetermined direct voltage to the thermistor 320 through the first and second electrodes 340, 345.

The submodule 360 has an internal space which enables the ferrule 170 to be inserted and is attached on the substrate 310.

The ferrule 370 has a shape of cavity cylinder that enables an optic fiber 380 to be inserted. The ferrule 370 is inserted to the internal space of the submodule 360, and is joined within the submodule 360 in a state wherein an end cross section of the optic fiber 380 is aligned to one end of the semiconductor laser chip 550.

As described above, as the thermistor 320 controls its heating value according to a change of an environmental temperature, temperature sensing and a control device are not needed. Furthermore, as the thermistor 320 does not employ a forced cooling method like a thermoelectric cooler, but uses an uncooled method, the structure is simple and the manufacturing cost is low.

In addition, as shown in FIG. 3, as the thermistor 320 can function as a substrate for directly applying signals to an optical element, it is possible for the thermistor 320 to be used directly as a substrate by arranging signal lines on the thermistor 320 without using a separate substrate that includes separate signal lines.

In other embodiments of the present invention, the thermistor 320 may be used with any type of semiconductor chip that requires a constant operation temperature. For example, in an optical communication module, a semiconductor optical amplifier may be mounted on the thermistor 320.

In the preferred embodiment described above, an uncooled optical communication module includes a semiconductor chip mounted on thermistor having a positive temperature coefficient. This arrangement can not only effectively deal with changes in the environmental temperature, but also reduce the volume and manufacturing cost of the total optical communication module as compared with the conventional prior art.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An uncooled optical communication module comprising:
a plate-shaped thermistor having a positive temperature coefficient so that resistance of the thermistor increases according to an increase of an environmental temperature;
a semiconductor chip mounted on an upper surface of the thermistor; and,
a driving means for applying a predetermined voltage to the thermistor.

2. The uncooled optical communication module as claimed in claim 1, wherein the thermistor has a heating characteristic defined by an equation,
$$P = \frac{{V}^{2}}{R} ,$$
wherein P represents a power consumption amount corresponding to a heating value of the thermistor, V represents a voltage applied to the thermistor, and R represents a resistance of the thermistor.

3. The uncooled optical communication module as claimed in claim 1, wherein the driving mean includes:
a first electrode and a second electrode laminated on both sides of the thermistor; and
a voltage source connected to the first electrode and the second electrode, which applies a predetermined voltage.

4. The uncooled optical communication module as claimed in claim 1, wherein the semiconductor chip is a semiconductor laser chip emitting light through one end of the semiconductor chip.

5. An optical communication module comprising:
a thermistor having a positive temperature coefficient so that resistance of the thermistor increases according to an increase of an environmental temperature;
a semiconductor chip thermally coupled to the thermistor; and,
a plurality of electrodes, coupled to the thermistor, arranged to connect a voltage source to the thermistor.

6. The optical communication module as claimed in claim 5, wherein the thermistor has a heating characteristic defined by an equation,
$$P = \frac{{V}^{2}}{R} ,$$
wherein P represents a power consumption amount corresponding to a heating value of the thermistor, V represents a voltage applied to the thermistor, and R represents a resistance of the thermistor.

7. The optical communication module as claimed in claim 5, wherein a voltage source is connected to the first electrode and the second electrode, which applies a predetermined voltage to the thermistor.

8. The optical communication module as claimed in claim 5, wherein the semiconductor chip is a semiconductor laser chip emitting light through one end of the semiconductor chip.

9. The optical communication module as claimed in claim 5, wherein the semiconductor chip is a semiconductor optical amplifier.
